(19) United States
(12) Patent Application Publication
(10) Pub. No.: US 2013/0208657 A1
(43) Pub. Date: Aug. 15, 2013

(54) METHOD AND SYSTEM FOR FACILITATING COMMUNICATION

(71) Applicant: Yoav Broshi, Tel Aviv (IL)

(72) Inventor: Yoav Broshi, Tel Aviv (IL)

(21) Appl. No.: 13/726,878

(22) Filed: Dec. 26, 2012

Related U.S. Application Data
(63) Continuation of application No. 12/391,429, filed on Feb. 24, 2009, now abandoned.
(60) Provisional application No. 61/031,022, filed on Feb. 25, 2008.

(51) Int. Cl. H04W 76/02

(52) U.S. Cl. CPC H04W 76/021
USPC 370/328

(57) ABSTRACT

A system for enabling at least a first mobile communication device and a second mobile communication device to establish communication, the system including a server adapted to receive from the first device an ID string associated with the second device, the ID string being obtained from the second device over a local communication link between the first and second devices, the server being adapted to program a switch or router so as to cause the switch or router to bridge communication between the first and second devices.

### FIELD OF THE INVENTION

The present invention generally relates to the field of communication. More specifically, the present invention relates to using a first local communication link to enable a first device to identify and establish a second communication link with a second device.

### BACKGROUND

In recent decades communication technology has revolutionized our everyday lives. Communication devices have become the platform upon which we conduct a large number of our daily personal and professional interactions. However, despite the tremendous proliferation of communication devices, these devices have, thus far, proved to be practically ineffectual in overcoming some of the basic psychological and social barriers which influence human interaction.

It has been found that merely providing people with an increased number of channels and/or modes of communication (e.g. cell phone, SMS, email, video conference, etc.) does not significantly increase the number of connections and meaningful interactions between people who do not already know one another. In other words, despite the quantum leap in communication technology and the relatively large number of communication channels over which one person may communicate with another, the task of making an initial contact with another person remains daunting for many, and virtually impossible for others.

Thus, there is a need for a method, a system and an apparatus to assist a user to overcome the psychological and/or social impediments associated with making an initial contact with another person. Furthermore, there is a need for a method, a system utilizing communication technology and/or devices to assist a user in overcoming the psychological and/or social impediments associated with making an initial contact with another person.

### SUMMARY OF THE INVENTION

There is provided, in accordance with some embodiments of the present invention, a method and a system for enabling at least a first mobile communication device and a second mobile communication device to establish communication. According to some embodiments of the present invention, the first device may establish a local communication link with the second device. In accordance with some embodiments of the present invention, the first device may be adapted to establish the local communication link with the second device upon sensing the second device or upon receiving a signal from the second device. The first device, over the local communication link, may obtain from the second device an ID string associated with the second device. According to some embodiments of the present invention, the second device may also receive from the first device an ID string associated with the first device.

According to some embodiments of the present invention, the first device may transmit an access request, including the ID string associated with the second device, to a server via a second data link. As part of one exemplary embodiment of the present invention, the first device may be connected to a distributed network which in turn may be connected to the server. Upon receiving the access request, the server may correlate the ID string associated with the second device with a connection string (e.g. a telephone number or a network address of an I.P. device) associated with the second device. A switch or router may be programmed in accordance with the connection string of the second user's device to enable the bridging of communication between the first and second devices.

According to some embodiments of the present invention, the first communication link may be established either via a Bluetooth or WiFi communication protocol. However, is should be understood that any means of wireless communication known today or to be developed in the future is applicable to the present invention.

According to some embodiments of the present invention, the access request may be transmitted to the server via a GPRS or any other wireless data link protocol known today or to be developed in the future. According to further embodiments of the present invention, an access request may be transmitted by the first device to the server via short message service (“SMS”), when the server has an SMS address (i.e. cellular network phone number).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a system for enabling at least a first mobile communication device and a second mobile communication device to establish communication, in accordance with some embodiments of the present invention;

FIG. 2 is a flowchart illustration of a method of enabling at least a first mobile communication device and a second mobile communication device to establish communication, in accordance with some embodiments of the present invention;

FIG. 3A is a flowchart illustration of a method of enabling at least a first mobile communication device and a second mobile communication device to establish communication, in accordance with some embodiments of the present invention;

FIG. 3B is a flowchart illustration of a method of enabling at least a first mobile communication device and a second mobile communication device to establish communication, in accordance with some embodiments of the present invention; and

FIG. 3C is a flowchart illustration of a method of enabling at least a first mobile communication device and a second mobile communication device to establish communication, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

There is provided, in accordance with some embodiments of the present invention, a method and a system for enabling at least a first mobile communication device and a second mobile communication device to establish communication. According to some embodiments of the present invention, the first device may establish a local communication link with the second device. In accordance with some embodiments of the present invention, the first device may be adapted to establish the local communication link with the second device upon sensing the second device or upon receiving a signal from the second device. The first device, over the local communication link, may obtain from the second device an ID string associated with the second device. According to some embodiments of the present invention, the second device may also receive from the first device an ID string associated with the first device.

According to some embodiments of the present invention, the first device may transmit an access request, including the ID string associated with the second device, to a server via a second data link. As part of one exemplary embodiment of the present invention, the first device may be connected to a distributed network which in turn may be connected to the server. Upon receiving the access request, the server may correlate the ID string associated with the second device with a connection string (e.g. telephone number or network address of an I.P. device) associated with the second device. A switch or router may be programmed in accordance with the connection string associated with the second device to bridge communication between the first and second devices.

It should be noted that the present invention is not limited to enabling communication between only two mobile communication devices (point-to-point). Rather, in accordance with some embodiments of the present invention, the system may enable the first device to establish communication with a plurality of devices (point-to-multipoint). The system may enable the first device to establish communication with the plurality of devices simultaneously or sequentially. The system may include and may utilize any presently known or yet to be devised in the future conferencing technology and components to enable a variety of communication schemes between the first device and one or more destination devices.

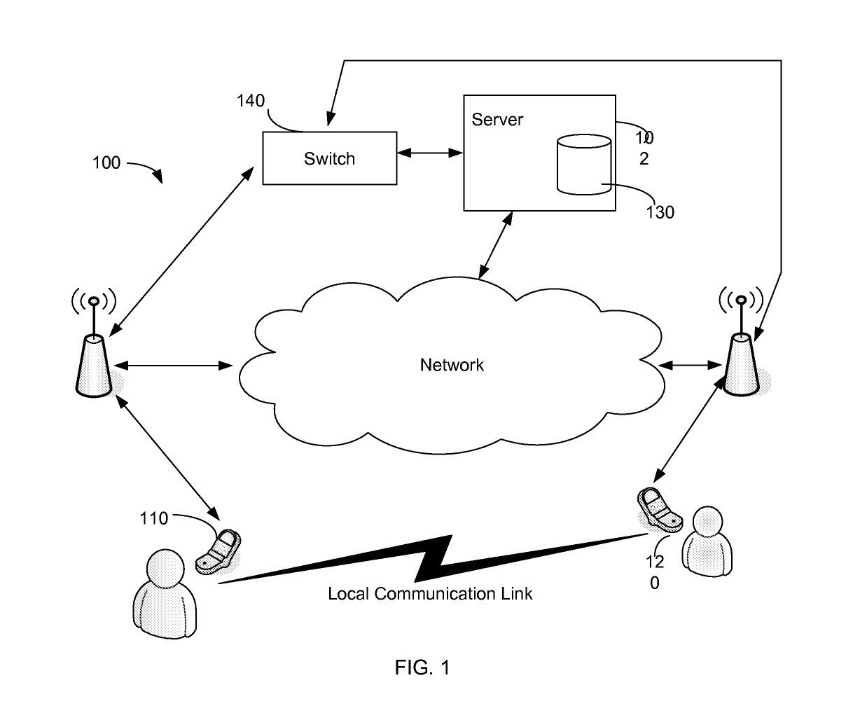

Reference is now made to FIG. 1, which is a block diagram illustrating a system for enabling at least a first mobile communication device and a second mobile communication device to establish communication, in accordance with some embodiments of the present invention. In accordance with some embodiments of the present invention, the system 100 may include a server 102 or any other computer or computer-like unit or machine. The server 102 may be adapted to receive from a first mobile communication device 110 an ID string associated with a second mobile communication device 120. The server 102 may be adapted to program a switch or a router 140 so as to cause the switch or router 140 to bridge communication between the first and second devices 110 and 120.

As part of some embodiments of the present invention, the first device 110 may be adapted to establish a local communication link with the second device 120. The first device 110 may be adapted to establish the local communication link with the second device 120 upon sensing the second device 120 or upon receiving a signal from the second device 120, for example. The first device 110 may obtain, over the local communication link, the ID string associated with the second device 120. As part of some embodiments of the present invention, the first device 110 may initially request the second device 120 to send (to the first device 110) an ID string associated with the second device 120, so that the first device 110 may establish communication with the second device 120. The second device 120 may respond to the request by sending, over the local communication link, to the first device 110 an ID string associated with the second device 120. The second device may also choose to ignore the request or may refuse to send the ID string to the first device 110. In case the second device 120 chooses to refuse the request from the first device 110, the second device 120 may send a message (e.g. an SMS message) to the first device 110 informing the first device 110 that the second device 120 refuses to provide it with an ID string associated with the second device 120.

The first and second devices 110 and 120 may include and may be adapted to utilize any communication components and communication protocols, known in the present or yet to be devised in the future, which may enable the first and second devices 110 and 120 to establish a local communication link, including, but not limited to Bluetooth, Wifi and/or other localized wireless communication components and protocols capable of enabling the first and second devices to establish a local communication link when the devices are in proximity to one another. For example, the first and second devices 110 and 120 may be Bluetooth enabled, and thus, when the first and second devices 110 and 120 are within range of each other's Bluetooth transceivers, a short range wireless connection may be established between the two devices 110 and 120.

As part of some embodiments of the present invention, the first device 110 may obtain from the second device 120, over the local communication link, an ID string associated with the second device 120. In accordance with some embodiments of the present invention, the ID string may include a set of characters associated with the second device 120. The set of characters in the ID string may be uniquely associated with the second device 120. For example, the ID string may include a system registry, address or number of the second device 120 in the system 100.

In accordance with some embodiments of the present invention, the first device 110 may transmit an access request, including the ID string associated with the second device 120, to the server 102 via a second data link. As part of one exemplary embodiment of the present invention, the server 102 may be connected to a distributed network, which in turn may be connected to the first device 110. Thus, the first device 110 may establish a second data link, over the distributed network, with the server 102, and may transmit to the server 102, over the second data link, the ID string associated with the second device 120.

In accordance with some embodiments of the present invention, upon receiving the access request, the server 102 may correlate the ID string associated with the second device 120 with a connection string (e.g. telephone number or network address of an I.P. device) associated with the second device 120. The server may program a switch or router 140 in accordance with the connection string of the second device 120 to bridge communication between the first and second devices 110 and 120.

In accordance with some embodiments of the present invention, the first device 110 may establish a third communication link with the switch or router 140, for example, by dialing a telephone number or inputting a browser with a network address of the switch or router 140. Upon receiving an incoming transmission from the first device 110, the switch or router 140 may switch or route the transmissions arriving from the first device 110 in accordance with the connection string with which the switch or router 140 may have been programmed by the server 102. In accordance with one exemplary embodiments of the present invention, upon receiving an incoming transmission from the first device 110, the switch or router, which had been preprogrammed with the connection string associated with the second device 120, may establish a fourth communication link with the second device 140. The switch or router 140 may switch or route transmissions arriving from the first device 110, over the third communication link, to the second device 120, over the fourth communication link, thereby bridging communication between the first and second devices 110 and 120.

In accordance with some embodiments of the present invention, the first device 110 may be adapted to transmit, the second device 120 may be adapted to receive and the switch or router 140 may be adapted to bridge communication in a variety of forms including, but not limited to, speech, text, video, audio and any combination thereof, in any presently known or yet to be devised in the future format, including but not limited to telephone digital transmissions, SMS or MMS, TCP/IP data transmissions (including VoIP transmissions) and/or GPRS data transmissions. Furthermore, the first and second devices 110 and 120 and the switch or router 140 may include and may utilize any presently known or yet to be devised in the future hardware and/or software components to enable such communication between the first and second devices 110 and 120.

It should be noted that the present invention is not limited to the use of the switch or router 140 fro bridging communication between the first a second devices 110 and 120, and that in accordance with some embodiments of the present invention other elements or components may be used to bridge communication between the first a second devices 110 and 120. Furthermore, in accordance with some embodiments of the present invention, the server 102, after receiving from the first device 110 the ID string associated with the second device 120, may, for example, establish a data link with the second device 120 via the distributed network, and may automatically forward transmissions arriving from the first device 110, over the second data link, to the second device 120, thereby bridging communication between the first and second devices 110 and 120. The server 102 may include and may utilize any presently known or yet to be devised in the future hardware and/or software components which may be required to enable the sever 102 to bridge communications between the first device 110 and the second device 120.

In accordance with some embodiments of the present invention, in addition to the ID string, the first device 110 may obtain profile data relating, for example, to one or more users associated with the second device 120. The profile data may include, but is not limited to, a user's (or users') system profile, a user's photograph, a user's voice message and additional personal and/or other information and data. In accordance with some embodiments of the present invention, the profile data may be private and the first device 110 may be required to request and be granted authorization from the second device 120 in order to be able to obtain the profile data associated with the second device 120.

In accordance with some embodiments of the present invention, the profile data may be stored on the second device 120. The second device 120 may be adapted to transmit the profile data to the first device 110 over the local communication link. In accordance with some embodiments of the present invention, the second device 120 may transmit to the first device 110 the profile data together with the ID string, however, in accordance with further embodiments of the present invention, the second device 120 may transmit the profile data in a separate transmission, either before or after sending the ID string associated with the second device 120 to the first device 110.

In accordance with some embodiments of the present invention, the server 102 may store profile data relating to a user or users associated with the second device 120. In accordance with one embodiment of the present invention, the server 102 may include or may be associated with a storage device 130, upon which storage device 130, the profile data relating to the user or users associated with the second device 120 may be stored. In accordance with some embodiments of the present invention, the storage device 130 may be used to store a plurality of additional profile data entries each of the plurality profile data entries being associated with a different communication device associated with the system 100. In accordance with some embodiments of the present invention, the server 102 may transmit to the first device 110, over the second data link, the profile data relating to a user or users associated with the second device 120.

As part of one embodiment of the present invention, prior to transmitting the profile data, the server 102 may request the first device 110 to provide authorization from the second device 120 to receive or otherwise access the profile data relating to the user or users associated with the second device 120. In accordance with this embodiment, the first device 110 may request the second device 120 to provide it with authorization to enable the first device 110 to receive or otherwise access the profile data stored on the server 102 relating to a user or users associated with the second device 120. As part of another embodiment of the present invention, after receiving a request from the first device 110 to access profile data relating to a user or users associated with the second device 120, the server 102 may establish a third data link with the second device 120, and over the third data link, the server 102 may request the second device 120 to provide authorization to the enable the first device 110 to receive or otherwise access the profile data relating to one or more users associated with the second device 120. In accordance with some embodiments of the present invention, the server 102 may transmit, over the third data link, to the second device 120 profile data relating to a user or users associated with the first device 110 together with the request to provide authorization to the enable the first device 110 to receive or otherwise access the profile data.

As part of one exemplary embodiment of the present invention, a first user, through a first device 110, after establishing a local communication link with a second device 120, may obtain from the second device 120 personal data relating to a user or users associated with the second device 120. After reviewing the profile data, the first user, through the first device 110, may send to the second device 120 a request to provide the first device 110 with an ID string associated with the second device 120 to enable the first device 110 to establish communication with the device 120. As part of some embodiments of the present invention, the first user, through the first device 110, may attach to the request profile data relating to the first user. The second device 120 may receive the request from the first device 110. As part of some embodiments of the present invention, the second device 120 may also receive together with the request, the profile data relating to the first user. A second user, through the second device 120 may review the profile data relating to the first user associated with the first device 110, and may send, through the second device 120, to the first device 110 the ID string associated with the second device 120. As discussed above, upon receiving the ID string from the second device 120, the first device 110 may be capable of establishing communication with second device 120 via switch or router 140 or via server 102.

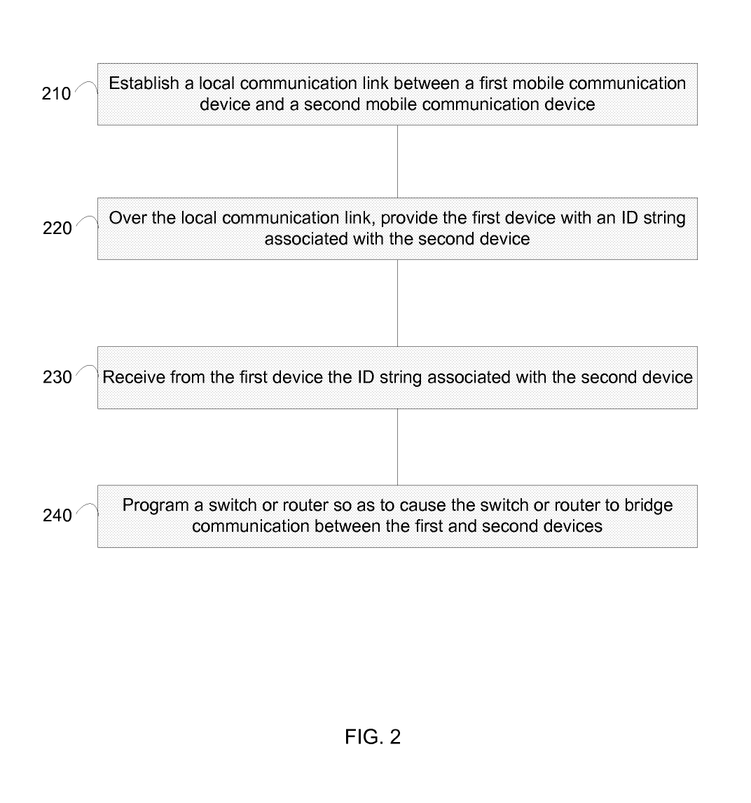

Reference is now made to FIG. 2 which is a flowchart illustration of a method of enabling at least a first mobile communication device and a second mobile communication device to establish communication, in accordance with some embodiments of the present invention. In accordance with some embodiments of the present invention, a local communication link between a first mobile communication device and a second mobile communication device may be established (block 210). As discussed above, in accordance with one exemplary embodiments of the present invention, the first and second devices may include Bluetooth transceivers. Thus, a local communication link between the first device and the second device may be established, for example, when the Bluetooth transceiver of the first device senses the Bluetooth transceiver of the second device.

In accordance with some embodiments of the present invention, over the local communication link, the first device may obtain from the second device an ID string associated with the second device (block 220). The first device may then transmit the ID string to a server or any other computer or computer-like unit or machine (block 230). Upon receiving the ID string associated with the second device, the server may program a switch or a router to bridge communication between the first and second devices (block 240).

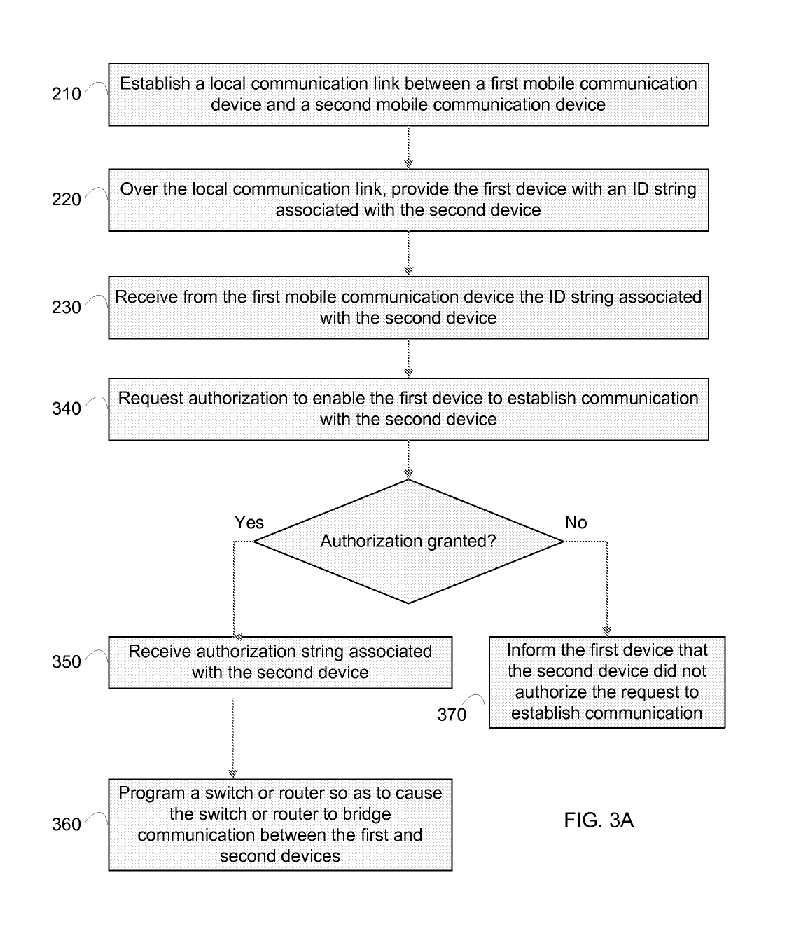

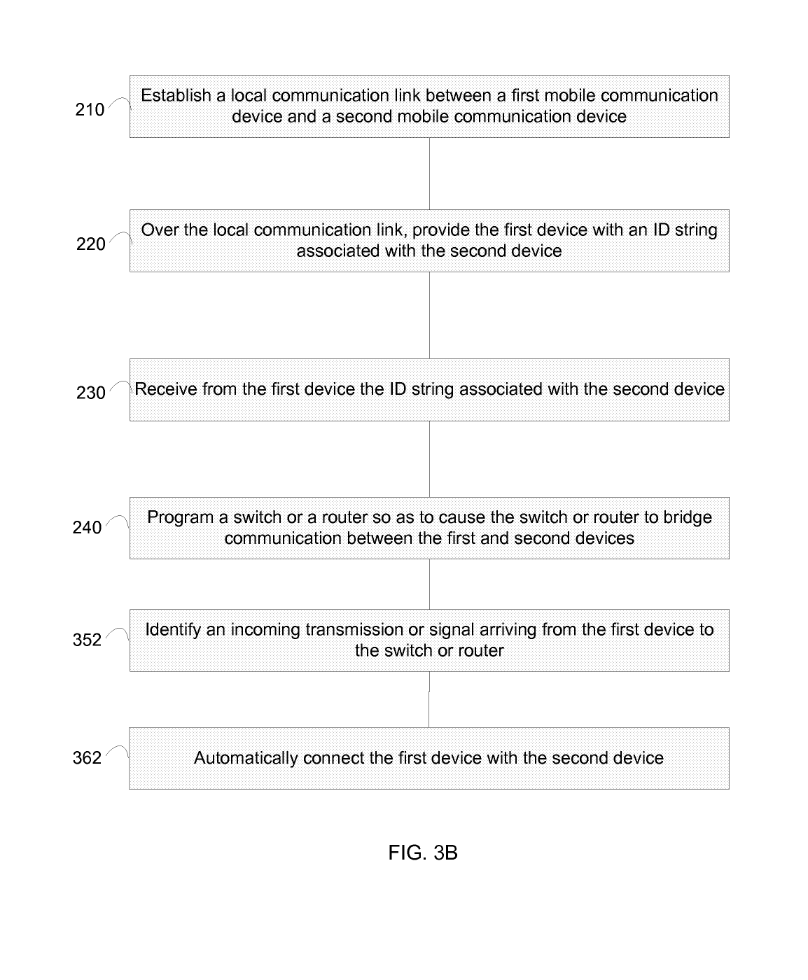

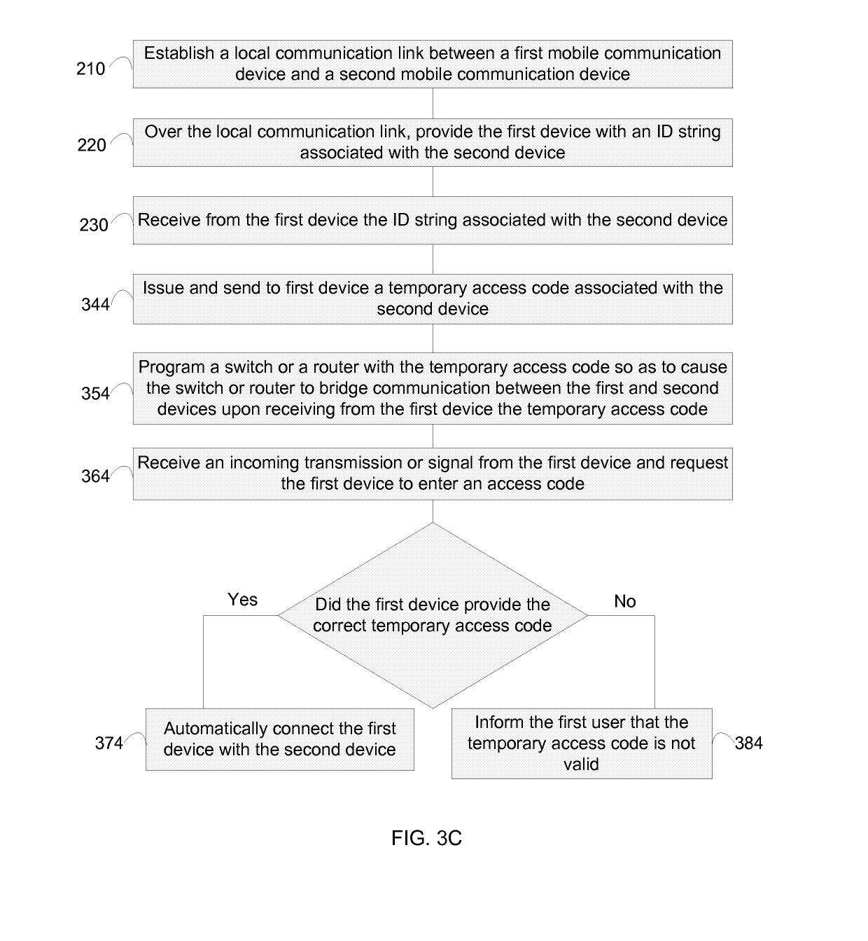

Reference is now made to FIG. 3A, which is a flowchart illustration of a method of enabling at least a first mobile communication device and a second mobile communication device to establish communication, in accordance with some embodiments of the present invention. In accordance with some embodiments of the present invention, a local communication link between a first mobile communication device and a second mobile communication device may be established (block 210). In accordance with some embodiments of the present invention, over the local communication link, the first device may obtain from the second device an ID string associated with the second device (block 220). The first device may then transmit the ID string associated with the second device to a server (block 230).

In accordance with some embodiments of the present invention, upon receiving the ID string associated with the second device, the server may require authorization in order to enable the first device to communicate with the second device (block 340). In case the second device authorizes the first device to communicate with the second device (block 350), the server may program a switch or router so as to cause the switch or router to bridge communication between the first and second devices (block 360). However, in accordance with some embodiments of the present invention, in case the second device refuses to authorize the first device to communicate with the second device, the first device may be informed that the second device did authorize its request to establish communication with the second device (block 370). For example, the server may send a message (e.g. an SMS message) to the first device, informing him that the server is unable to establish communication between the first device and second device. It should be noted however that the response described in block 370 is exemplary in nature and that in accordance with some embodiments of the present invention, the first device may not necessarily be receive any response in case the second device does not authorize the first device's request to enable it to communicate with the second device.

In accordance with some embodiments of the present invention, the first device, over the local communication link, may request from the second device authorization to enable it device to establish communication with the second device. The second device may respond to the authorization request by transmitting, over the local communication link, an authorization string to the first device. The second device may transmit the authorization string either together with the ID string or separately, either before or after the transmission of the ID string.

In accordance with further embodiments of the present invention, upon receiving from the first device the ID string associated with the second device, the server may establish a third data link with the second device, and over the third data link, the server may request authorization from the second device to enable the first device to establish communication with the second device. The second device may respond to the authorization request by transmitting, over the third data link, an authorization string to the server. The second device may also transmit the authorization string, over the local communication link, to the first device and the first device may transmit the authorization string, over the second data link, to the server.

In accordance with one exemplary embodiment of the present invention, the first device may initially receive from the second device, over the local communication link, an ID string together with profile data relating to a user or users associated with the second device. After reviewing the profile data, a first user through the first device may request from the second device, over the local communication link, for example, authorization to establish communication with the second device. In response to the authorization request, the second device may transmit to the first device, over the local communication link, for example, an authorization string. The first device may then establish a second data link with a server and may transmit to the server, over the second data link, the ID string and the authorization string associated with the second device. Upon receiving the ID string and the authorization string associated with the second device, the server may program a switch so as to enable the first device to communication with the second device.

In accordance with another exemplary embodiment of the present invention, the first device may initially receive from the second device, over the local communication link, an ID string associated with the second device, optionally, together with profile data relating to a user or users associated with the second device. The first device may then establish a second data link with a server and may transmit to the server, over the second communication link, an access request including the ID string associated with the second device. Upon receiving the access request including the ID string associated with the second device, the server may establish a third data link with the second device. Over the third data link, the server may request authorization from the second the device to enable the first device to establish communication with the second device. In accordance with one exemplary embodiment of the present invention, the server may transmit to the second device profile data relating to a user or users associated with the first device together with the request for authorization to enable the first device to establish communication with the second device. The second device may respond to the authorization request by transmitting, over the third data link, for example, an authorization string to the server. Upon receiving the authorization string from the second device, the server may program a switch or a router so as to enable the first device to establish communication with the second device.

Reference is now made to FIG. 3B, which is a flowchart illustration of a method of enabling at least a first mobile communication device and a second mobile communication device to establish communication, in accordance with some embodiments of the present invention. In accordance with some embodiments of the present invention, a local communication link between a first mobile communication device and a second mobile communication device may be established (block 210). In accordance with some embodiments of the present invention, over the local communication link, the first device may obtain from the second device an ID string associated with the second device (block 220). The first device may then transmit the ID string associated with the second device to a server (block 230). The server may program a switch or a router so as to cause the switch or router to bridge communication between the first and second devices (block 240).

In accordance with some embodiments of the present invention, the switch may identify an incoming transmission or signal arriving from the first device to the switch or router (block 352). In accordance with some embodiments of the present invention, the switch may include any necessary hardware and/or software components which may be necessary to enable the switch or router to determine the source of an incoming transmission. In other words, and with reference to the embodiment shown in FIG. 3B, the switch may include any necessary hardware and/or software components which may be necessary to enable the switch or router to identify an incoming transmission as originating from the first device. Such components may include but are not limited to, Automatic Number Identification (ANI) circuits or similar circuits commonly used in some circuit switch networks to determine the telephone number of a communication device associated with an incoming signal or transmission, and a TCP/IP enabled network device (e.g. a modem or a router) or similar devices and/or circuits capable of determining an IP address of a communication device associated with an incoming transmission or signal arriving over a TCP/IP network.

In accordance with some embodiments of the present invention, upon determining that a transmission or signal arriving at the switch is coming from the first device, the switch or router may automatically connect the first device with the second device (block 362). In accordance with one exemplary embodiment of the present invention, the switch or router may receive an incoming transmission or signal over a fourth communication link. The switch may check the incoming transmission or signal to determine the source of the transmission or signal. In accordance with some embodiments of the present invention, in case the switch or router determines that the transmission or signal is arriving from first device, the switch or router may establish a fifth communication link between the switch or router and the second device. The switch or router may then automatically forward communications arriving from the first device, over the fourth communication link, to the second device, over the fifth communication link, and from the second device to the first device, thereby bridging communication between the first and second devices.

Reference is now made to FIG. 3C, which is a flowchart illustration of a method of enabling at least a first mobile communication device and a second mobile communication device to establish communication, in accordance with some embodiments of the present invention. In accordance with some embodiments of the present invention, a local communication link between a first mobile communication device and a second mobile communication device may be established (block 210). In accordance with some embodiments of the present invention, over the local communication link, the first device may obtain from the second device an ID string associated with the second device (block 220). The first device may then transmit the ID string associated with the second device to a server (block 230).

In accordance with some embodiments of the present invention, upon receiving the ID string associated with the second device, the server may issue a temporary access code associated with the second device and may transmit the temporary access code over the second communication link to the first device (block 344). The server may also program a switch or a router with the temporary access code so as to cause the switch or router to bridge communication between the first and second devices upon receiving from the first device the temporary access code (354). At some point thereafter, the first device may establish a fourth communication link with the switch or router. The switch or router may request the first device to enter an access code (364). In case the first device provides the switch or router with the temporary access code associated with the second device, the switch or router may establish a fifth communication link between the switch or router and the second device. The switch or router may then automatically forward communications arriving from the first device, over the fourth communication link, to the second device, over the fifth communication link, and from the second device to the first device, thereby bridging communication between the first and second devices.

In accordance with some embodiments of the present invention each temporary access may be used only once or may be used a predetermined number of times by the first device to establish communication with the second device and may expire or become invalid after one or after a predetermined number of uses. For example, in accordance with one embodiment of the present invention, once the switch or router has successfully established communication between the first and second devices, the connection string with which the switch or router had been programmed to enable the switch or router to connect the first device with the second device may be erased from the switch's memory, such that the first device may no longer establish communication with the second device via the switch or router using the erased temporary access code.

In accordance with some embodiments of the present invention the server may issue and send to the first device a plurality of temporary access codes. In accordance with further embodiments of the present invention, each of the plurality of temporary access codes issued by the server and sent to the first device may be associated with a different destination mobile communication device. However, in accordance with yet further embodiments of the present invention, two or more of the plurality of temporary access codes may be associated with one of the destination devices. In accordance with some embodiments of the present invention, the server may program a switch or a router with each of the temporary access codes. Thus, as described above, the first device may establish a communication link with each of the plurality of destination devices by establishing a fourth communication link with the switch or router and entering a valid access code associated with one of the destination communication devices, thereby causing the switch or router to bridge communication between the first device and the destination device associated with the temporary access codes provided by the first device is associated, and repeating this process for each of destination devices.

What we claim is:

1. A system for enabling at least a first mobile communication device and a second mobile communication device to establish communication, said system comprising:
a server adapted to receive from the first device an ID string associated with the second device, said ID string being obtained from the second device over a local communication link between the first and second devices, said server being adapted to program a switch or router so as to cause the switch or router to bridge communication between the first and second devices.

2. The system according to claim 1, wherein the local communication link is either a Bluetooth or a wifi communication link.

3. The system according to claim 1, wherein the local communication link is either a IRDA or a zigbee communication link.

4. The system according to claim 1, wherein said server receives the string from the device over a network communication link.

5. The system according to claim 4, wherein the network communication link is a cellular communication link.

6. A method of enabling at least a first user's mobile communication device and a second user's mobile communication device to establish communication, said method comprising:
receiving from the first device an ID string associated with the second device, the ID string being obtained from the second device over a local communication link between the first the second devices; and
programming a switch or router so as to cause the switch or router to bridge communication between the first and second devices.

7. The method according to claim 6, wherein receiving over a local communication link further comprises receiving over either a Bluetooth or a wifi communication link.

8. The method according to claim 6, wherein receiving over a local communication link further comprises receiving over either an IRDA or a Zigbee communication link.

9. The system according to claim 6, wherein receiving the string from the device is performed over a network communication link.

10. The system according to claim 9, wherein receiving the string from the device is performed over a cellular communication link.
